(19) United States
(12) Patent Application Publication
(10) Pub. No.: US 2026/0251387 A1
(43) Pub. Date: Aug. 27, 2026

(54) CRYOGENIC BOILER

(71) Applicant: Blue Origin Manufacturing, LLC, Huntsville, AL (US)

(72) Inventors: James W. Nord, Jupiter, FL (US); Gary D. Grayson, Maple Valley, WA (US); Evan C. Rege, Indialantic, FL (US); Troy William Gehrett, Longmont, CO (US); Jason Patrick McMacken, Denver, CO (US); Scott F. Sherod, Auburn, WA (US); Joshua R. Calvert, Littleton, CO (US); James P. Cassidy, Oro Valley, AZ (US); Michael Friedman, Belton, TX (US)

(21) Appl. No.: 19/064,475

(22) Filed: Feb. 26, 2025

(51) Int. Cl. F25J 1/02; B64G 1/40

(52) U.S. Cl. CPC F25J 1/0242; B64G 1/402; F25J 1/0229; F25J 2250/20; F25J 2270/02; F25J 2290/70

(57) ABSTRACT

A boiler system and methods of operating the system are disclosed. The boiler system, which converts a cryogenic liquid to its gas phase, may be used in various types of space vehicles for various types of missions. Among other sources, the system principally operates using waste heat that is invariably produced during the many functions and processes that occur during space flight. Waste heat may be collected and applied to a heat exchanger in a recirculating loop that includes a boiler tank, where the cryogenic liquid is resultantly heated to a gas, which may be subsequently used or collected in one or more accumulator tanks, for example. If waste heat is used in this liquid-to-gas conversion process, the boiler system consumes relatively low amounts of energy produced by, or stored in, a space vehicle.

### BACKGROUND

Gaseous reactants, propellants, and utility gases like gaseous oxygen and hydrogen are used for a variety of functions in a space vehicle. Because oxygen and hydrogen are most often stored as cryogenic liquids, a liquid-gas conversion system would be useful. Such conversion systems may operate using combustion via a burner/heat-exchanger to gasify the liquids and a high pressure pump to compress the gas for storage. This type of operation, which could present energy consumption and reliability concerns, may likely consume reactants (e.g., a fuel and an oxidizer) and likely involve parasitic fluid loss from various cryogenic purges and chill-down operations. In addition, operations in low-gravity require special attention to the behavior and dynamics of liquid and gas phases of the cryogenic liquids (e.g., propellants). Thus, demand continues for a reliable liquid-gas conversion system that has relatively low mass, energy efficiency, and simple manufacturability, while being operable in the confines and limited resources involved in space flight or other space missions.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 is schematic flow diagram of a boiler system, according to some embodiments.

FIG. 2 is a schematic view of a boiler system, according to some embodiments.

FIG. 3 is a schematic view of a boiler system, according to some other embodiments.

FIG. 4 is a schematic view of a boiler system, according to still other embodiments.

FIG. 5 is a flow diagram of an example process for operating a boiler system in a low-gravity environment, according to some embodiments.

### DETAILED DESCRIPTION

This disclosure describes systems and methods of operating a recirculating boiler in a low-gravity spacecraft propulsion and fluid system, though claimed subject matter is not limited to low-gravity environments. The boiler system, which converts a cryogenic liquid to its gas phase, may be used in various types of space vehicles (e.g., including lunar stations and planetary stations) for various types of missions. In some implementations, the system may operate using waste heat that is invariably produced during the many functions and processes that occur during space flight, for example. The waste heat is collected and applied to a boiler tank in the system, where cryogenic liquid is resultantly heated to a gas at increased pressure that may subsequently be used or collected in one or more accumulator tanks. When waste heat is used in this liquid-to-gas conversion process, the boiler system generally consumes relatively low amounts of energy produced by, or stored in, a space vehicle. The boiler system may also involve relatively few mechanical parts so that it may be considered more reliable and less massive, as compared to a liquid-to-gas conversion system that relies on a combustion-or pneumatically driven-pump, burner, and a heat exchanger. For example, the boiler system, in some passive implementations, may operate using only tanks, valves, a blower, and available waste heat from avionics, fuel cells, and an electrical power system. The boiler system may also be operated in an active implementation, where burners or electric heaters, for example, may be used to add heat to the system. These sources of heat may be used in place of, or in addition to, waste heat.

In some embodiments, a boiler system on a space vehicle includes a cryogenic tank, herein referred to as a “main” tank, that provides a cryogenic liquid, which may be hydrogen or oxygen for example, to a boiler tank. The boiler system further includes a recirculation loop that includes the boiler tank, a blower, and a heat exchanger, which is configured to add heat to the recirculation loop to gasify the cryogenic liquid to a gas or to heat already-existing gas. The added heat is based, at least in part, on waste heat applied to the heat exchanger and produced by one or more processes in various locations in the space vehicle. The one or more processes may involve a hydraulic system, fuel cells, or a fuel/oxidizer propulsion system, just to name a few examples.

The system may also include additional heat exchangers or heating elements for adding heat from sources other than those that produce waste heat. For example, the recirculation loop may further include a burner-heat exchanger system that includes a combustion device. The burner-heat exchanger system may be configured to add heat to the recirculation loop to gasify the cryogenic liquid to a gas. In another example, the recirculation loop may further include an electric heater to add heat to the recirculation loop to gasify the cryogenic liquid to a gas.

The boiler tank may include an output port to vent gas produced from boiling the cryogenic liquid in the boiler tank. The vented gas may be used as a consumable by other systems in the space vehicle. For example, the vented gas may be used in thrusters (e.g., a fuel/oxidizer propulsion system) and/or may be used by the combustion device of the burner-heat exchanger system mentioned above.

The boiler system may also include a heat collector to collect waste heat from various locations of the space vehicle. A heat transfer path may be used to transfer the waste heat from the heat collector to a heat exchanger that is functionally coupled to the recirculation loop. At least a portion of the heat transfer path may be a conduit to carry heated fluid or a solid heat conductive material (e.g., a metal strap). The heat collector may be configured to collect waste heat produced by a propulsion system (e.g., rocket engines), avionics, fuel cells, hydraulics, and electrical power systems, just to name a few examples. The system may include a thermal switch that controls thermal energy flow in the heat transfer path, though claimed subject matter is not limited in this respect.

As mentioned above, in some embodiments, waste heat need not be relied upon to operate the boiler system. For example, one or more heat exchangers that are functionally coupled to the recirculation loop may be configured to receive exhaust from a combustion device (e.g., a burner-heat exchanger system). A resistance coil heater may also be functionally coupled to the recirculation loop. The resistance coil heater may be electrically connected to an electric current source, such as a generator, batteries, or solar panels, just to name a few examples.

In some embodiments, a boiler tank in a cryogenic boiler system, which may be operating in a low-gravity environment for example, may receive a cryogenic gas. The system may comprise a first recirculation loop that includes the boiler tank, a first blower, and a heat exchanger. The heat exchanger may be configured to add heat to the first recirculation loop to heat the cryogenic gas. The system may also comprise a preliminary tank to receive a cryogenic liquid from a main tank. The preliminary tank may be configured to convert the cryogenic liquid to the cryogenic gas by, at least in part, volume expansion. The preliminary tank may be located between the main tank and the boiler tank and may be configured to provide the cryogenic gas to the boiler tank. The system may also comprise a second recirculation loop that includes the preliminary tank and a second blower. The first recirculation loop may further include a second heat exchanger that is configured to pull heat from a flow of the cryogenic gas in the first recirculation loop so as to cool at least a portion of the boiler tank and the cryogenic gas that is in the boiler tank. In some implementations, two or more of such systems may be linked together, depending on end-user needs.

In some embodiments, a method of operating a boiler system, which may be in a low-gravity environment, includes transferring a cryogenic liquid from a main tank to a boiler tank wherein the cryogenic liquid is converted to a gas. Heat may be added, via a heat exchanger, to a flow of the gas in a recirculation loop that includes the boiler tank and a blower. To actively circulate the gas in the recirculation loop, the blower may blow the gas into the boiler tank, as explained below. The added heat may be based, at least in part, on waste heat applied to the heat exchanger and produced by at least one part of a space vehicle. The gas may be output from the boiler tank (e.g., either directly from the boiler tank or from the recirculation loop) for use in a combustion device or a thruster. In some implementations, the recirculation loop may include a burner-heat exchanger system that includes the combustion device, which may be used to add heat to the recirculation loop to gasify the cryogenic liquid to a gas. In some cases, as described below, the boiler tank may be prepared to be refilled by pulling heat from the flow of the gas in the recirculation loop so as to cool at least a portion of the boiler tank and the gas that is in the boiler tank.

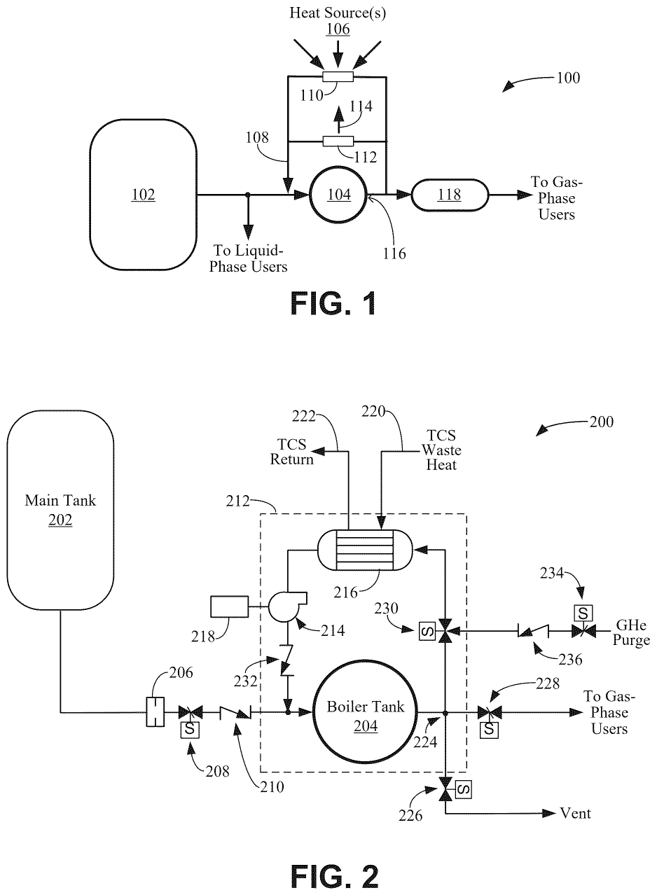

FIG. 1 is schematic flow diagram of a boiler system 100 according to some embodiments. Boiler system 100, which may operate in a space vehicle, includes a cryogenic tank 102 that stores a cryogenic liquid, such as liquid oxygen (LO2) or liquid hydrogen (LH2). Cryogenic tank 102 may provide its stored cryogenic liquid to any number of destinations that use cryogenic liquid, such as a propulsion system that combusts a fuel-oxidizer mixture. Other uses of cryogenic liquid may include orbital maneuvering system engines, electrical power generation, and hydraulic operations, among other things. Cryogenic tank 102 may also provide its stored cryogenic liquid to a boiler tank 104. Boiler system 100 may be configured so that waste heat is provided from outside the boiler tank 104. The waste heat may be produced by one or more heat sources 106 in various locations in the space vehicle. In some implementations, heat sources 106 may also include devices or systems that intentionally produce heat (e.g., non-waste heat), as explained below. Boiler system 100 may comprise a recirculation loop 108 that includes one or more heat exchangers that receive heat, via one or more heat exchangers 110, from the various heat sources and apply the heat to a flow of a fluid in the recirculation loop. For example, the fluid may be cryogenic liquid, gas, or a mixture of both phases depending, at least in part, on a stage of progress of system 100 for converting the liquid from cryogenic tank 102 to a gas in boiler tank 104. As explained below, recirculation loop 108 may also include a blower fan to blow gas in the recirculation loop into boiler tank 104.

In some implementations, a portion of recirculation loop 108 may include a heat exchanger 112 for pulling heat 114 out of the flow of fluid in the recirculation loop. Such a process may lead to cooling of the fluid flow and also cooling of boiler tank 104 and the gas therein. This cooling may be useful for a process of refilling the boiler tank and/or adjusting the temperature and pressure of the boiler tank and the gas therein to desired values.

Boiler tank 104 includes an output port 116 to vent gas produced from boiling the cryogenic liquid in the boiler tank by the received waste heat (and/or intentionally-produced heat). In some implementations, boiler system 100 may further include one or more accumulator tanks 118 that receive the vented gas from output port 116. The one or more accumulator tanks may provide to users the gas phase of the cryogenic liquid that was previously stored in cryogenic tank 102. In other implementations, boiler tank 104 of system 100 may directly provide to users the gas phase of the cryogenic liquid that was previously stored in cryogenic tank 102. For sake of illustrative clarity, various valves among tanks in boiler system 100 are not illustrated.

FIG. 2 is a schematic view of a boiler system 200 of a space vehicle, according to some embodiments. Boiler system 200 may be the same as or similar to system 100. For example, boiler system 200 may include a main tank 202 (e.g., cryogenic tank 102) and a boiler tank 204 (e.g., boiler tank 104). The main tank may be configured to store a cryogenic liquid (e.g., LO2 or LH2). The exit of main tank 202 may include a pressure-dropping orifice 206 and valves 208 and 210. When valves 208 and 210 are open, boiler tank 204 may receive cryogenic liquid from main tank 202. For example, valve 208 may be a flow control valve and valve 210 may be a pressure relief valve. Valves illustrated and identified herein are merely examples, and claimed subject matter is not limited with respect to placement of any particular types of valves in any particular locations.

Boiler system 200 may also include a recirculation loop 212 that includes boiler tank 204, a blower 214, and a heat exchanger 216. Heat added to recirculation loop 212 via the heat exchanger may gasify cryogenic liquid and/or heat gas that has already phase-changed from liquid. The gasification and/or heating may occur primarily in boiler tank 204 but may also occur in recirculation loop 212. Blower 214, which may be powered by an electric motor 218, may be configured to blow gas, which may include relatively small amounts of liquid mixed therein, toward boiler tank 204. In detail, gas flowing in recirculation loop 212 from heat exchanger 216 through blower 214 may experience a small pressure increase as the gas flows toward the boiler tank. Generally, such a pressure increase by the blower is substantially smaller than a pressure increase that would be produced by a pump, for example. The pressure increase by the blower is sufficient to create flow currents inside boiler tank 204 as the blown gas proceeds to flow through the boiler tank back into the recirculation loop. These flow currents generally allow for greater efficiency of thermal mixing as heat of the influx of gas from the recirculation loop enters the boiler tank.

In some implementations, the heat added to heat exchanger 216 is, at least in part, waste heat produced by one or more processes in various locations in the space vehicle. For example, the waste heat may be from a thermal control system (TCS) that is configured to collect heat from hydraulic systems, fuel cells, or fuel/oxidizer propulsion systems, just to name a few examples. An arrow 220 indicates TCS waste heat being input to heat exchanger 216 and an arrow 222 indicates the heat exchanger output that may be recirculated in a waste-heat collecting loop (not illustrated). For example, at least a portion of the heat collecting loop may be a conduit to carry heated fluid. The system may include a thermal switch that controls thermal energy flow (e.g., heat) in the heat collecting loop, though claimed subject matter is not limited in this respect.

Though boiler system 200 is herein described as using waste heat, other types of heat may instead, or additionally, be used. Claimed subject matter is not limited with respect to types or sources of heat that are provided to heat exchange 216. For example, system 200 may also include additional heat exchangers or heating elements for adding heat from sources other than those that produce waste heat. The recirculation loop may include a burner-heat exchanger system or electric heater, which are in some embodiments that are described below.

Boiler tank 204 may include an output port 224 that leads to several flow paths. One path may be for venting the gas produced from boiling the cryogenic liquid in the boiler tank. For example, the gas may be vented (e.g., to vacuum) from boiler tank 204 to chill the contents of the boiler tank. The venting flow rate may be controlled by a flow control valve 226. Another path may be for providing the gas from the boiler tank as a consumable to gas-phase users, which may be any of a number of systems in the space vehicle, such as a fuel/oxidizer propulsion system or a combustion device of a burner-heat exchanger system. The flow rate of the gas supply to users may be controlled by a flow control valve 228. In some implementations, gas flowing through control valve 228 may be collected into one or more accumulator tanks (not illustrated) that receive the vented gas from output port 224. Thus, on demand, the one or more accumulator tanks may provide the gas phase of the cryogenic liquid that was previously stored in main tank 202 to one or more systems in the space vehicle. In some implementations, a series of such accumulator tanks may be filled sequentially as boiler tank 204 continues to produce and vent gas. In other implementations, two or more accumulator tanks may be filled in parallel with vented gas.

Still another path from output port 224 may be recirculation loop 212. The flow rate of gas in loop 212 may be determined by a flow control valve 230 and a pressure relief valve 232. In some implementations, a flow control valve 234 and a pressure relief valve 236 may control flow of helium for purging or cooling various portions of system 200.

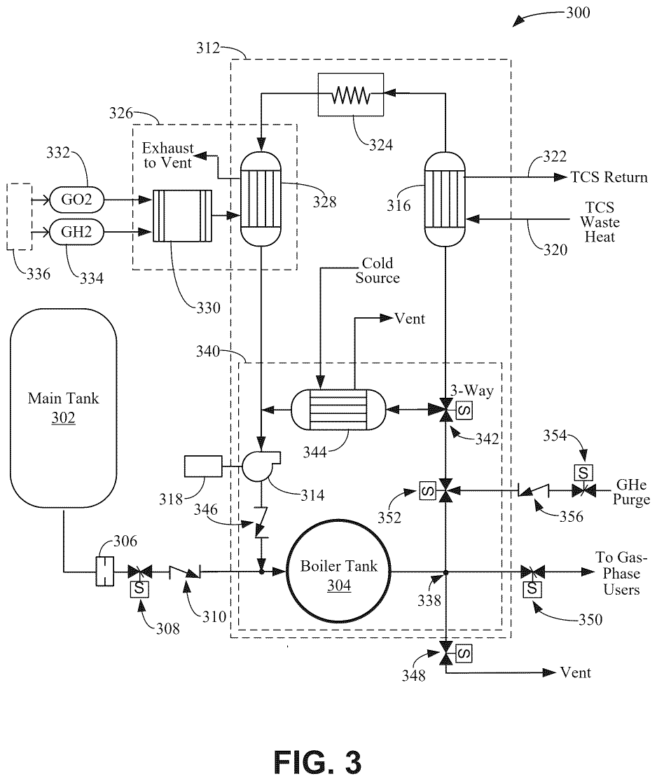

FIG. 3 is a schematic view of a boiler system 300 of a space vehicle, according to some embodiments. Boiler system 300 may operate as a passive system, similar to or the same as how boiler system 200 may be operated (e.g., using waste heat). Boiler system 300, however, includes features that allow it to be operated non-passively, wherein heat is specifically generated for the operation of producing gas from a cryogenic liquid. Boiler system 300 may also include waste heat collectors and paths to utilize waste heat. By controlling various valves in the system, for example, any of the multiple heat sources, whether waste heat, intentionally-produced heat, or both, may be selected based on mission parameters or operation of the space vehicle. For example, a selection of a heat source may be based on the time scale of operation. Generally, intentionally-produced heat may be available, and in a higher quantity, in a relatively short time as compared to the time of availability of waste heat. Accordingly, if a mission or operation of a space vehicle requires production of gas in a short time span, then boiler system 300 may use intentionally-produced heat instead of, or in addition to, waste heat. On the other hand, if a mission or operation of a space vehicle is a long-term endeavor that only requires production of gas over a long period of time, then boiler system 300 may avoid using intentionally-produced heat (to conserve resources) and instead use only waste heat. In another example, operation(s) of a space vehicle may produce excess waste heat that may best be expended by heat absorption during a process of producing gas from liquid in a boiler tank. In this case, there may not be a need to intentionally produce heat by consuming fuel or electricity stored in batteries, for example.

Boiler system 300 may be the same as or similar to system 100 and has some similarities to system 200. For example, boiler system 300 may include a main tank 302 (e.g., main tank 202) and a boiler tank 304 (e.g., boiler tank 204). Main tank 302 may be configured to store a cryogenic liquid (e.g., LO2 or LH2). The exit of main tank 302 may include a pressure-dropping orifice 306 and valves 308 and 310. When valves 308 and 310 are open, boiler tank 304 may receive cryogenic liquid from main tank 302. For example, valve 308 may be a flow control valve and valve 310 may be a pressure relief valve.

Boiler system 300 may also include a recirculation loop 312 that includes boiler tank 304, a blower 314, and a heat exchanger 316. Heat added to recirculation loop 312 via the heat exchanger may gasify cryogenic liquid and/or heat gas that has already phase-changed from liquid. The gasification and/or heating may occur primarily in boiler tank 304 but may also occur in recirculation loop 312. Blower 314, which may be powered by an electric motor 318, may be configured to blow gas, which may include relatively small amounts of liquid mixed therein, toward boiler tank 304. In detail, gas flowing in recirculation loop 312 from heat exchanger 316 through blower 314 may experience a small pressure increase as the gas flows toward the boiler tank. Generally, as mentioned above, such a pressure increase by the blower is substantially smaller than a pressure increase that would be produced by a pump, for example. The pressure increase by the blower is sufficient to create flow currents inside boiler tank 304 as the blown gas proceeds to flow through the boiler tank back into recirculation loop 312. These flow currents may allow for greater efficiency of thermal mixing as heat of the influx of gas from the recirculation loop enters the boiler tank.

In some implementations, heat added to heat exchanger 316 is, at least in part, waste heat produced by one or more processes in various locations in the space vehicle. For example, the waste heat may be from a TCS that is configured to collect heat from hydraulic systems, fuel cells, or fuel/oxidizer propulsion systems, just to name a few examples. An arrow 320 indicates TCS waste heat being input to heat exchanger 316 and an arrow 322 indicates the heat exchanger output that may be recirculated in a waste-heat collecting loop (not illustrated).

In addition to including boiler tank 304, blower 314, and heat exchanger 316, recirculation loop 312 may also include an electric heater 324 and a burner-heat exchanger system 326. Accordingly, though boiler system 300 may use waste heat, other types of heat may instead, or additionally, be used. These non-passive, non-waste heat sources may be used, for example, if conversion of cryogenic liquid to gas is needed relatively quickly or during short-duration missions. Electric heater 324 may be an electric resistance coil that is configured to heat the flow of liquid or gas in recirculation loop 312. Burner-heat exchanger system 326 may include a heat exchanger 328 to receive heat from a combustion burner 330, which may combust a mixture of gaseous O2 and H2 to generate the heat. For example, combustion burner 330 may combust a vaporized mixture of a fuel and an oxidizer. Flow to and from an accumulator tank 332 for gaseous O2 (e.g., the oxidizer) and an accumulator tank 334 for gaseous H2 (e.g., the fuel) may be controlled by a pressurization control system 336. In some implementations, the O2 in accumulator tank 332 may be provided by an output 338 of boiler tank 304 for the case where boiler system 300 is operating on cryogenic oxygen. Similarly, the H2 in accumulator tank 334 may be provided by output 338 of boiler tank 304 for the case where boiler system 300 is operating on cryogenic hydrogen.

As described above, recirculation loop 312 may include heat exchanger 316, electric heater 324, and burner-heat exchanger system 326. Thus, this portion of recirculation loop 312 may be considered a heating loop that, by one or more sources of heat, injects the heat into boiler system 300. Recirculation loop 312 may also include a cooling loop 340 that may be in parallel with at least a portion of the heating loop. A three-way flow control valve 342 may be used to control flow rates to both the heating loop and the cooling loop. In some implementations, cooling loop 340 includes a heat exchanger 344 that is configured to cool liquid or gas that is flowing in the cooling loop. A cold source, such as a relatively cold fluid (e.g., liquid and/or gas) circulating in a loop, may be applied to heat exchanger 344. Generally, by controlling three-way valve 342, either the cooling loop or the heating loop will have a flow of liquid or gas, depending on whether boiler tank 304 is to be heated or cooled. Blower 314 may be configured to push (e.g., blow) either a flow from the cooling loop or a flow from the heating loop so that either flow is blown and well-circulated in boiler tank 304, whether for heating or cooling. A pressure relief valve 346 may, at least in part, control flow from the heating and cooling loops into the boiler tank.

Cooling loop 340 may be useful for a process where boiler tank 304 is to be cooled. For example, after gas produced and contained in boiler tank 304 has been used (or stored elsewhere) and the boiler tank is substantially empty, the boiler tank may be refilled with cryogenic liquid from main tank 302. In preparation for the refilling of the cryogenic liquid, it may be beneficial to cool boiler tank 304 so that the pressure therein is lower than the pressure of the cryogenic liquid in main tank 302. This pressure differential may allow for avoiding the need for pumps, for example. Another reason for cooling may be to avoid thermal shock of the boiler tank by the influx of cold cryogenic liquid from main tank 302.

Output port 338 of boiler tank 304 may lead to several flow paths. One path may be for venting the gas produced from boiling the cryogenic liquid in the boiler tank. For example, gas may be vented from boiler tank 304 to chill the contents of the boiler tank. The venting flow rate may be controlled by a flow control valve 348. Another path may be for providing the gas from the boiler tank as a consumable to gas-phase users, which may be any of a number of systems in the space vehicle, such as a fuel/oxidizer propulsion system or a combustion device of a burner-heat exchanger system. The flow rate of the gas supply to such users may be controlled by a flow control valve 350. In some implementations, gas flowing through control valve 350 may be collected into one or more accumulator tanks (not illustrated) that receive the vented gas from output port 338. Thus, on demand, the one or more accumulator tanks may provide the gas phase of the cryogenic liquid that was previously stored in main tank 302 to one or more systems in the space vehicle. In some implementations, a series of such accumulator tanks may be filled sequentially as boiler tank 304 continues to produce and vent gas. In other implementations, two or more accumulator tanks may be filled in parallel with vented gas.

Still another path from output port 338 may be recirculation loop 312, which, in part, includes cooling loop 340. The flow rate of gas in loop 312 may be determined by a flow control valve 352 and pressure relief valve 346. In some implementations, a flow control valve 354 and a pressure relief valve 356 may control flow of helium for purging or cooling various portions of system 200.

In some embodiments, a process of operating boiler system 300 for hydrogen or oxygen includes a number of steps. For example, in describing the use of only one gas, as a first step, an operator may pre-charge or fill, as appropriate, tanks on the ground, such as before a launch. Subsequently, the operator may add heat as needed during storage and may discharge gas to control temperatures. During utilization of the gas, the operator may allow the gas to discharge down to a minimum pressure by one or more gas users. If a cooling device is incorporated, boiler tank 304 may be pre-chilled by exchanging heat between residual gases in the boiler tank (and recirculation loop 312 or 340) and cold sources. The operator may then vent the boiler tank to vacuum or other users (e.g., slowly, if possible) to assist in this chilling process. Such chilling of the boiler tank may be performed with blower 314 on. After sufficient chilling of the boiler tank, the operator may open one or more valves from main tank 302 and fill boiler tank 304 until check valve 310 checks or the boiler tank is adequately filled. Such filling may be optimized by injecting only the necessary mass for the final chill cycle, so as not to wastefully “over-chill.” The operator may then allow the temperature of the boiler tank and the mass therein to stabilize. The operator may vent the boiler tank to vacuum (slowly, if possible) to assist in the chilling process. After the boiler tank is sufficiently chilled, venting valve 348 may be closed to isolate the boiler tank from vacuum. Some of the previous steps for chilling may be repeated to obtain adequately chilled gas in boiler tank 304.

After being adequately chilled, the operator may partially fill the boiler tank with cryogenic liquid from main tank 302 via head pressure of the main tank. The fill level may determine the final temperature for a given pressure target. The operator may then charge boiler tank 304 by exchanging heat with TCS waste heat and/or supplemental heat sources (e.g., electric heater 324 and burner-heat exchanger system 326) as necessary to achieve the desired pressure within the allotted time. These previous steps may be repeated for producing additional “batches” of gas from the cryogenic liquid that is stored in main tank 302.

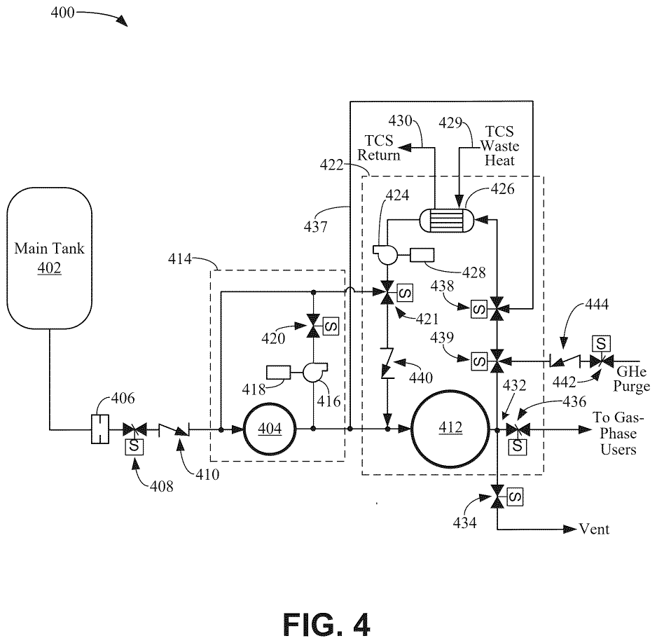

FIG. 4 is a schematic view of a boiler system 400, according to some embodiments. Portions of boiler system 400 may be the same as or similar to system 200. One particular difference between system 400 and system 200 is that system 400 includes a preliminary tank that receives a cryogenic liquid from a main tank and, in turn, provides the cryogenic liquid to a boiler tank, as described below.

Boiler system 400 may include a main tank 402 that provides a cryogenic gas to a preliminary tank 404 via a pressure-dropping orifice 406 and valves 408 and 410. For example, valve 408 may be a flow control valve and valve 410 may be a pressure relief valve. A boiler tank 412 may receive cryogenic gas from preliminary tank 404. Though boiler tank 412 is herein named with the word “boiler”, claimed subject matter is not limited to such a tank that accommodates or experiences actual boiling of its contents. Orifice 406 may lead to a pressure drop to limit the flow from main tank 402 to rest of the system. It may be useful since tanks 404 and 412 will likely be at low pressures while main tank 402 may remain mostly at a higher pressure, enough to sonically choke the flow somewhere in the lines of the system.

Preliminary tank 404 is configured to convert the cryogenic liquid from main tank 402 to cryogenic gas by, at least in part, volume expansion. Preliminary tank 404 is located between main tank 402 and boiler tank 412 and is configured to provide the cryogenic gas to the boiler tank. Boiler system 400 may also include a first recirculation loop 414 that includes preliminary tank 404 and a first blower 416 powered by a motor 418. A flow control valve 420 may control flow in the first recirculation loop. Cryogenic fluid may flow through loop 414 from main tank 402 and, depending on the system operation at hand, may i) flow through first blower 416 and circulate clockwise to chill preliminary boiler 404 enough to receive cryogenic liquid, or ii) may flow to a valve 421, thus bypassing preliminary boiler 404. Valve 421 may be a 3-way valve that allows fluid flow from preliminary boiler 404 to fill boiler tank 412 or allows fluid of boiler tank 412 to recirculate via a second recirculation loop 422 while receiving no flow from preliminary boiler 404, as explained below.

Second recirculation loop 422 includes boiler tank 412, a second blower 424, and a heat exchanger 426. Second recirculation loop 422 is similar to or the same as loop 212 of system 200, for example. A three-way valve 421 may at least partially control the flow in second recirculation loop 422 and also may control of a flow from first recirculation loop 414 to second recirculation loop 422.

Heat added to second recirculation loop 422 via the heat exchanger may heat gas that has already phase-changed from liquid in preliminary tank 404. The heating may occur primarily in boiler tank 412 but may also occur in second recirculation loop 422. Second blower 424, which may be powered by an electric motor 428, may be configured to blow gas toward and into boiler tank 412. In detail, gas flowing in second recirculation loop 422 from heat exchanger 426 through second blower 424 may experience a small pressure increase as the gas flows toward the boiler tank. The pressure increase by the blower is sufficient to create flow currents inside boiler tank 412 as the blown gas proceeds to flow through the boiler tank back into second recirculation loop 422. These flow currents generally allow for greater efficiency of thermal mixing as heat of the influx of gas from the recirculation loop enters the boiler tank.

In some implementations, heat added to heat exchanger 426 is, at least in part, waste heat produced by one or more processes in various locations in a space vehicle or other system. For example, the waste heat may be from a TCS that is configured to collect heat from hydraulic systems, fuel cells, or fuel/oxidizer propulsion systems, just to name a few possibilities. An arrow 429 indicates TCS waste heat being input to heat exchanger 410 and an arrow 430 indicates the heat exchanger output that may be recirculated in a waste-heat collecting loop (not illustrated).

An output port 432 of boiler tank 412 may lead to several flow paths. One path may be for venting the gas in the boiler tank. For example, gas may be vented from boiler tank 412 to chill the contents of the boiler tank. The venting flow rate may be controlled by a flow control valve 434. Another path may be for providing the gas from the boiler tank as a consumable to gas-phase users, which may be any of a number of systems in, for example, a space vehicle, such as a fuel/oxidizer propulsion system or a combustion device of a burner-heat exchanger system. The flow rate of the gas supply to such users may be controlled by a flow control valve 436. In some implementations, gas flowing through control valve 436 may be collected into one or more accumulator tanks (not illustrated) that receive the vented gas from output port 432. In turn, the vented gas at output port 432 may be sourced directly from boiler tank 412 or from preliminary tank 404 by bypassing boiler tank 412 via a path 437 and a valve 438. Thus, on demand, the one or more accumulator tanks may provide the gas phase of the cryogenic liquid that was previously stored in main tank 402 to one or more systems in the space vehicle. In some implementations, a series of such accumulator tanks may be filled sequentially as boiler tank 404 continues to produce vented gas. In other implementations, two or more accumulator tanks may be filled in parallel with vented gas.

Still another path from output port 432 may be second recirculation loop 422. The flow rate of gas in loop 422 may be determined by a flow control valve 439 and pressure relief valve 440. In some implementations, a flow control valve 442 and a pressure relief valve 444 may control flow of helium for purging or cooling various portions of system 400.

In some embodiments, a process of operating boiler system 400 for hydrogen or oxygen includes a number of steps. For example, as a first step, an operator may chill and partially fill preliminary tank 404 with cryogenic liquid from main tank 402. The operator may then add enough heat to the preliminary tank to ensure that the cryogenic liquid has converted to all gas after equalization. Subsequent to this, the operator may discharge usable gas from boiler tank 412. The operator may then open an isolation valve to equalize pressures between the preliminary tank and the boiler tank. After this isolation valve is closed, the operator may switch over to heating boiler tank 412 to a desired pressure, which should be lower than the pressure in the preliminary tank. The operator may then vent the preliminary tank into the boiler tank.

In some implementations, preliminary tank 404 may be metallic and be able to handle cryogenic liquids and boiler tank 412 may be a composite bottle (e.g., tank) that can only handle warm temps (e.g., not cryogenic fluids). For example, a minimum temperature that a composite bottle may safely tolerate may be about minus 300 degrees F. LH2 may be about minus 421 degrees F., which may be too cold for nonmetallic bottles. In a two-step process, fluid in 404 may be heated to temperatures that can be tolerated by the composite bottle, then the warmed fluid may flow into the boiler tank 412. Metal tanks are generally much heavier than composite tanks. Because weight considerations are important for space vehicles, the size of tank 404 may be minimized relative to tank 412.

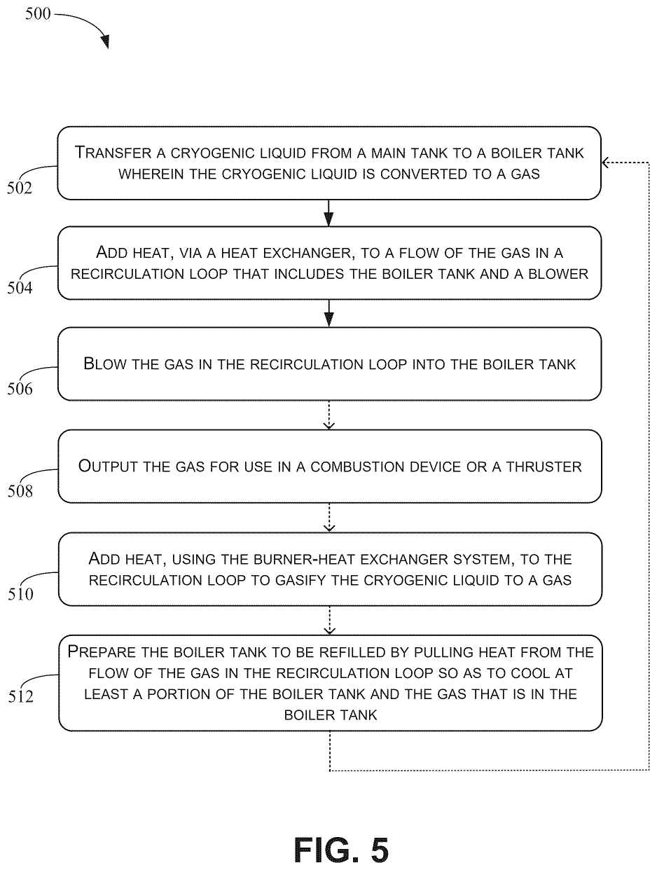

FIG. 5 is a flow diagram of an example process 500 for operating a boiler system, such as 200 or 300, in a low-gravity environment, according to some embodiments. For example, the process may be performed by an operator such as a crew member, an electronic controller, a computer processing system following computer-executable instructions, or a combination thereof.

At 502, the operator may transfer a cryogenic liquid from a main tank to a boiler tank wherein the cryogenic liquid is converted to a gas. In the case for system 300, for example, the operator may transfer cryogenic liquid from main tank 302 to boiler tank 304 by operating one or more valves, such as 306, 308, and 308. At 504, the operator may add heat, via a heat exchanger, to a flow of the gas in a recirculation loop that includes the boiler tank and a blower. In the case for system 300, for example, the operator may add the heat to the flow via heat exchanger 316, electric heater 324, and/or burner-heat exchanger system 326, all of which may be in recirculation loop 312. At 506, the operator may blow the gas, using blower 314, for example, in the recirculation loop into the boiler tank.

In particular implementations, process 500 may continue to 508 where the operator may output the gas from the boiler tank for use in a combustion device or a thruster. In the case for system 300, for example, the operator may output the gas from boiler tank 304 via output port 338 into recirculation loop 312, via valve 352, for use in combustion burner 330, into a path, via valve 350, that leads to a thruster or other gas-phase user(s). At 510, the operator may add heat, using burner-heat exchanger system 326, to recirculation loop 312 to gasify the cryogenic liquid to a gas and/or to further heat already-existing gas. In some implementations of operating system 300, at 512, the operator may prepare boiler tank 304 to be refilled by pulling heat from the flow of gas using heat exchanger 344 in recirculation loop 340 so as to cool at least a portion of the boiler tank and the gas that is in the boiler tank. In general, depending on particular requirements of a mission, for example, process 500 may return to 502 to refill the boiler tank with cryogenic liquid and proceed to convert the liquid to a gas.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments or examples are presented by way of examples for purposes of illustration and description. They are not intended to be exhaustive of or to limit this disclosure to the precise forms described. Many modifications and variations are possible in view of the above teachings. The embodiments or examples are shown and described in order to best explain the principles of this disclosure and practical applications, to thereby enable others skilled in the art to best utilize this disclosure and various embodiments or examples with various modifications as are suited to the particular use contemplated. It is intended that the scope of this disclosure be defined by the following claims and their equivalents.

We claim as follows:

1. A cryogenic boiler system for operating in a low-gravity environment, the system comprising:
a boiler tank to receive a cryogenic liquid from a main tank; and
a recirculation loop that includes the boiler tank, a blower, and a heat exchanger, wherein the heat exchanger is configured to add heat to the recirculation loop to gasify the cryogenic liquid to a gas.

2. The system of claim 1, wherein the added heat is based, at least in part, on waste heat applied to the heat exchanger and produced by at least one part of a space vehicle.

3. The system of claim 2, wherein the at least one part of the space vehicle is a hydraulic system of the space vehicle.

4. The system of claim 2, wherein the at least one part of the space vehicle is a fuel cell.

5. The system of claim 2, wherein the at least one part of the space vehicle is a fuel/oxidizer propulsion system of the space vehicle.

6. The system of claim 1, wherein the heat exchanger is a first heat exchanger and wherein the recirculation loop further includes a second heat exchanger that is configured to pull heat from a flow of the cryogenic gas in the recirculation loop so as to cool at least a portion of the boiler tank and the cryogenic gas that is in the boiler tank.

7. The system of claim 6, wherein the first heat exchanger is located in the recirculation loop in parallel with the second heat exchanger.

8. The system of claim 1, further comprising an output port on the recirculation loop between the boiler tank and the heat exchanger to output the gas to vent the gas or to use the gas in a combustion device or a thruster.

9. The system of claim 8, wherein the recirculation loop further includes a burner-heat exchanger system that includes the combustion device, and wherein the burner-heat exchanger system is configured to add heat to the recirculation loop to gasify the cryogenic liquid to a gas.

10. The system of claim 1, wherein the recirculation loop further includes an electric heater to add heat to the recirculation loop to gasify the cryogenic liquid to a gas.

11. A cryogenic boiler system comprising:
a boiler tank to receive a cryogenic gas;
a first recirculation loop that includes the boiler tank, a first blower, and a heat exchanger, wherein the heat exchanger is configured to add heat to the first recirculation loop to heat the cryogenic gas;
a preliminary tank to receive a cryogenic liquid from a main tank, wherein
the preliminary tank is configured to convert the cryogenic liquid to the cryogenic gas by, at least in part, volume expansion, and
the preliminary tank is located between the main tank and the boiler tank and is configured to provide the cryogenic gas to the boiler tank; and
a second recirculation loop that includes the preliminary tank and a second blower.

12. The system of claim 11, wherein the heat exchanger is a first heat exchanger and wherein the first recirculation loop further includes a second heat exchanger that is configured to pull heat from a flow of the cryogenic gas in the first recirculation loop so as to cool at least a portion of the boiler tank and the cryogenic gas that is in the boiler tank.

13. The system of claim 11, further comprising an output port on the first recirculation loop between the boiler tank and the heat exchanger to output the cryogenic gas to vent the cryogenic gas or to use the cryogenic gas in a combustion device or a thruster.

14. The system of claim 13, wherein the first recirculation loop further includes a burner-heat exchanger system that includes the combustion device, and wherein the burner-heat exchanger system is configured to add heat to the first recirculation loop to heat the cryogenic gas.

15. The system of claim 11, wherein the recirculation loop further includes an electric heater that is configured to add heat to the first recirculation loop to heat the cryogenic gas.

16. A method of operating a cryogenic boiler system, the method comprising:
transferring a cryogenic liquid from a main tank to a boiler tank wherein the cryogenic liquid is converted to a gas;
adding heat, via a heat exchanger, to a flow of the gas in a recirculation loop that includes the boiler tank and a blower; and
blowing the gas in the recirculation loop into the boiler tank.

17. The method of claim 16, wherein the added heat is based, at least in part, on waste heat applied to the heat exchanger and produced by at least one part of a space vehicle.

18. The method of claim 16, further comprising outputting the gas for use in a combustion device or a thruster.

19. The method of claim 18, wherein the recirculation loop further includes a burner-heat exchanger system that includes the combustion device, and further comprising:
adding heat, using the burner-heat exchanger system, to the recirculation loop to gasify the cryogenic liquid to a gas.

20. The method of claim 16, further comprising:
preparing the boiler tank to be refilled by pulling heat from the flow of the gas in the recirculation loop so as to cool at least a portion of the boiler tank and the gas that is in the boiler tank.
